(19) United States
(12) Patent Application Publication
(10) Pub. No.: US 2018/0284430 A1
(43) Pub. Date: Oct. 4, 2018

(54) HEAD-UP DISPLAY SYSTEM OF ALL TIME

(71) Applicant: E-LEAD ELECTRONIC CO., LTD., CHANGHUA (TW)

(72) Inventor: Stephen CHEN, CHANGHUA (TW)

(21) Appl. No.: 15/474,999

(22) Filed: Mar. 30, 2017

(51) Int. Cl. G02B 27/01; G02B 5/30

(52) U.S. Cl. CPC G02B 27/0101; G02B 2027/0118; G02B 5/30

(57) ABSTRACT

The present invention relates to a head-up display system of all time, which includes a display device, a windshield, a wedge plate and a half-wave plate, wherein the display device projects s-polarized light and p-polarized light, the half-wave plate is used to let s-polarized light and p-polarized light interchange with each other between the windshield, the wedge plate and the half-wave plate, to thereby provide displayed images with optimized visual effects for all time, to improve driving safety effectively.

### BACKGROUND OF THE INVENTION

### a) Field of the Invention

The present invention relates to a head-up display system of all time and, more particularly, to a head-up display system of all time provided for all weather without visual impairment, to solve the drawback that a polarized sunglasses couldn't be used to read images displayed by head-up displays and overcome the image distorted problem in rainy days, to thereby provide drivers with displayed images with optimized visual effects for all time, to improve driving safety effectively.

### b) Description of Prior Art

Head-up displays of vehicle would be usually set below the dashboard under the windshield, and image light would be projected upwards to the is windshield and rejected to driver's eyes by the windshield. The angle of windshields of common vehicles, especially passenger cars, is 25˜35 degrees above the horizontal, for safety considerations, angle of view of head-up displays would be usually designed at about 5 degrees below drivers' horizontal line of sight, so that it would not only be easily read by drivers, but not block important line of sight, by calculating from such an angle, the incident angle of image light of head-up displays to the windshield is about 60˜70 degrees.

As shown in FIG. 1, it is a curve diagram of s-polarized light, p-polarized light and reflectivity according to Fresnel Equations. It would be known from the figure that the reflectivity of s-polarized light is far greater than the reflectivity of p-polarized light in the range of the incident angle, the reflectivity of p-polarized light is even close to zero if the incident angle is close to 60 degrees. Thus, screen of head-up displays should be strong for drivers to read when vehicles are in the strong sunshine. In order to increase projection efficiency of head-up displays, s-polarized light may be chosen as a light source of an imaging screen of a common head-up display, or image light output from the imaging screen may be converted to s-polarized light by using a suitable wave plate and then projected to the windshield for obtaining greater amount of reflected light.

As shown in FIG. 2, a half-wave plate 1 is used with s-polarized light (s shown in figure), so that low-reflection problem of Brewster's angle and invisible problem of polarized sunglasses could be solved. Now, it is illustrated as an example that the incident angle θ1 is about 22 degrees, when an s-polarized light respectively passes through the innermost layer G1 and the outermost layer G2 of the windshield G, s-polarized light reflects on an outer layer of the innermost layer G1 of the windshield G, wherein the reflectivity of p-polarized light (p as shown in figure) and s-polarized light (please refer to FIG. 1), s-polarized light obtained 26% of amount of reflected light and 74% of amount of transmitted light; when the transmitted light passes through the half-wave plate 1 between the innermost layer G1 and the outermost layer G2 of the windshield, p-polarized light interchanges with s-polarized light and reflects on is the outer layer of the outermost layer G2 of the windshield G, 2.6% (74%×3.5%) of amount of reflected light of p-polarized light is obtained and passes the half-wave plate 1 again, p-polarized light interchanges with s-polarized light again, and 2.6% of s-polarized light passes through the outer layer of the innermost layer G1 of the windshield G, 1.9% (2.6%×74%) of s-polarized light is obtained, a multiple image of s-polarized light 26% and 1.9% is generated.

When sunlight slants in, many drivers may drive with wearing sunglasses. In the market, there is a kind of high-end sunglasses made of polarizer for filtering s-polarized light in the environment, because light source may be directly reflected on surface of objects contacted to air in nature easily, the reflected light is usually not with the color of the object itself, but reflects the color of the light source directly like a mirror, this situation may cause obstruction to driver's sight; similarly, reflected light of the surfaces is mostly s-polarized light according to Fresnel Equations, thus sunglasses provided to filter s-polarized light may filter most of reflected light of object surfaces, so that colors of objects look more vivid and easily to identify.

However, image light projected by head-up displays is mainly s-polarized light, information displayed by head-up displays cannot be read with using this kind of polarized sunglasses, so that the utility of head-up displays is greatly reduced, it is the reason why head-up displays cannot be popular and widely used though helpful to drivers' safety. Until now, all of the head-up displays provided to display on windshields in the market cannot be read with wearing polarized sunglasses.

As shown in FIG. 3, the half-wave plate 1 with p-polarized light could solve low-reflection problem of Brewster's angle and invisible problem of polarized sunglasses. Now, it is illustrated as an example that the incident angle θ1 is about 22 degrees, when a p-polarized light respectively passes the innermost layer G1 and the outermost layer G2 of the windshield G, p-polarized light reflects on the outer layer of the innermost layer G1 of the windshield G, wherein the reflectivity of p-polarized light and s-polarized light (please refer to FIG. 1), p-polarized light obtained 3.5% of amount of reflected light and 96.5% of amount of transmitted light; when the transmitted light passes through the half-wave plate 1 between the innermost layer G1 and the outermost layer G2 of the windshield G, p-polarized light interchanges with s-polarized light and reflects on the outer layer of the outermost layer G2 of the windshield G, 25.1% (96.5%×26%) of amount of reflected light of s-polarized light is obtained and passes the half-wave plate 1 again, p-polarized light interchanges with s-polarized light again, and 25.1% of p-polarized light passes through the outer layer of the innermost layer G1 of the windshield G,24.2% (25.1%×96.5%) of p-polarized light is obtained, a multiple image of p-polarized light 3.5% and 24.2% is generated, so that images could be seen with using polarized sunglasses, but the reflective layer is mainly the outermost layer G2 of the windshield G; and, as shown in FIG. 4, when raindrops attach to the windshield G in rainy days, the reflective surface is not a smooth surface, so it may be affected by raindrops, namely, when it rains, images of HUD may have irregular distortion, it causes images being distorted, this problem may also let the utility of head-up displays be greatly reduced.

In order to solve the above problems, the industry propose solutions continuously, related technology could be referred to cited references JP published patent application 2-141720, U.S. Pat. No. 5,510,913, TW patent number 171642, 393582, TW publication number 201017214, 201022722, 201621399, 201626045, TW patent certificate number 1422860, 146449, 1545375, 1554785.

### SUMMARY OF THE INVENTION

In view of the drawbacks of the conventional ones, the inventor finally completed the head-up display system of all time of the present invention after numerous improvements, namely, the object of the present invention is to provide a head-up display system of all time provided for all weather without visual impairment, to solve the drawback that a polarized sunglasses couldn't be used to read images displayed by head-up displays and overcome the image distorted problem in rainy days, to thereby provide drivers with displayed images with optimized visual effects for all time, to improve driving safety effectively.

To achieve the object of the present invention, the head-up display system of all time of the present invention includes:

a display device, which is the display device with S-polarized light and P-polarized light;

a windshield, which includes a first glass and a second glass, S-polarized light and P-polarized light projected by the display device are reflected by an outer layer of the first glass and an outer layer of the second glass;

a wedge plate, which is set between the first glass and the second glass;

a half-wave plate, which is set between the first glass and the second glass.

The above display device, which includes a projection device and an imaging screen, the imaging screen is a 45 degree linear polarization, circular polarization or elliptical polarization imaging screen, wherein the ratio of s-polarized and p-polarized light is equal.

The above display device, which includes a projection device and an linear polarized imaging screen by using s-polarized light, a wave plate is covered on the imaging screen, so as to convert output image light into approximately half of s-polarized light and half of p-polarized light in advance.

The above display device, which includes a projection device and an linear polarized imaging screen by using p-polarized light, a wave plate is covered on the imaging screen, so as to convert output image light into approximately half of s-polarized light and half of p-polarized light in advance.

The bottom of the above half-wave plate is attached to the display location of the second glass, the bottom of the wedge plate is attached to the top of the first glass, and the second glass is covered on.

The head-up display system of all time of the present invention further includes a transparent plastic plate, the half-wave plate is set between the transparent plastic plate and the wedge.

The bottom of the above half-wave plate is attached to the display location of the first glass, the bottom of the wedge plate is attached to the top of the first glass and the half-wave plate, and the second glass is covered on.

The above head-up display system of all time, wherein the display device includes a projection device and an imaging screen.

The half-wave plate is a transparent plastic material plate body.

The wedge plate is a transparent PVB material plate body.

### BRIEF DESCRIPTION OF THE DRAWINGS

FIG. 1 is a curve diagram of s-polarized light, p-polarized light and reflectivity according to Fresnel equations in prior art;

FIG. 2 is a schematic diagram of light path of s-polarized light passing through the half-wave plate in prior art;

FIG. 3 is a schematic diagram of light path of p-polarized light passing through the half-wave plate in prior art;

FIG. 4 is a schematic diagram of reflected light path of a windshield with raindrops attached on its surface in prior art;

FIG. 5 is a schematic diagram of the first embodiment of the present invention;

FIG. 6 is a schematic diagram of light path of the first embodiment of the present invention;

FIG. 7 is a schematic diagram of the second embodiment of the present invention;

FIG. 8 is a schematic diagram of the third embodiment of the present invention; and

FIG. 9 is another schematic diagram of the third embodiment of the present invention.

### DETAILED DESCRIPTION OF THE INVENTION

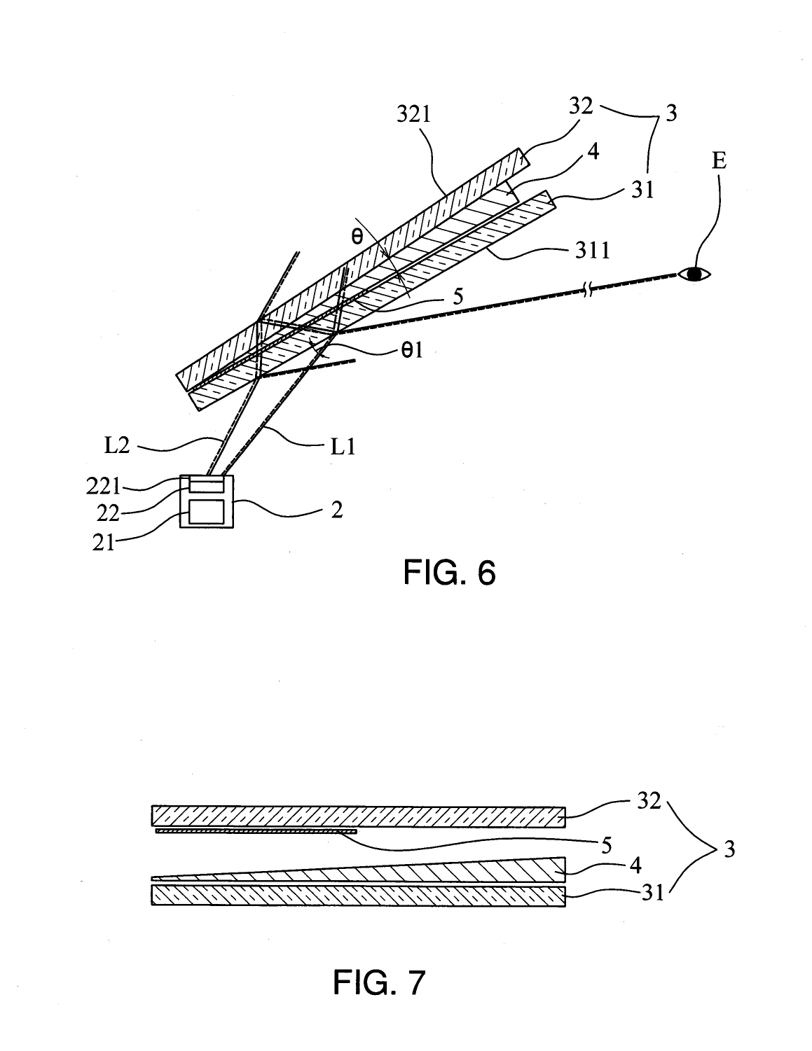

Please refer to FIG. 5, FIG. 6, which is the first embodiment of the head-up display system of all time of the present invention, the head-up display system of all time of the present invention includes:

a display device 2, which includes a projection device 21 and an imaging screen 22;

a windshield 3, which includes a first glass 31 and a second glass 32;

a wedge plate 4, which is set between the first glass 31 and the second glass 32, the wedge plate 4 is a transparent PVB material plate body;

a half-wave plate 5, which is set between the first glass 31 and the second glass 32, the half-wave plate 5 is a transparent plastic material plate body.

The head-up display system of all time of the present invention, wherein the bottom of the above half-wave plate 5 is attached to the display location of the first glass 31, the bottom of the wedge plate 4 is attached to the top of the first glass 31 and the half-wave plate 5, the second glass is covered on, and then deaeration and gluing procedures are performed.

As shown in FIG. 6, wherein the display device 2 projects approximately the same amount of s-polarized light and p-polarized light, s-polarized light reflects on the outer layer 311 of the first glass 31 that the amount of reflection is much greater than p-polarized light, rest of s-polarized light and p-polarized light interchange with each other after transmitting the half-wave plate 5, by the outer layer 321 of the second glass, s-polarized light interchanged from the transmitted p-polarized light reflects on the outer layer 321 of the second glass 32 that the amount of reflection is much greater than p-polarized light interchanged from the transmitted s-polarized light, the reflected s-polarized light interchanges into p-polarized light by the half-wave plate 5 and is reflected by the outer layer 311 of the first glass 31.

The above display device 2, which includes a projection device 21 and an imaging screen 22, the imaging screen 22 is a 45 degree linear polarization, circular polarization or elliptical polarization imaging screen, wherein the ratio of s-polarized and p-polarized light is equal.

The display device 2 includes a projection device 21 and a linear polarized imaging screen by using s-polarized light, a wave plate 221 is covered on the imaging screen, so as to convert output image light into approximately half of s-polarized light and half of p-polarized light in advance.

The display device 2 includes a projection device 21 and a linear polarized imaging screen by using p-polarized light, a wave plate 221 is covered on the imaging screen, so as to convert output image light into approximately half of s-polarized light and half of p-polarized light in advance.

Now, it is illustrated as an example that the incident angle θ1 is about 22 degrees, the outer layer 311 of the first glass 31 and the outer layer 321 of the second glass 32 of the windshield 3 may reflect image light, thus, the head-up display system of all time of the present invention may generate multiple images; through precise calculation, the angle θ of the wedge plate 4 is between 0.005˜1 degree, so that the wedge plate 4 could let the image light reflected from the outer layer 311 of the first glass 31 and the image light reflected from the outer layer 321 of the second glass 32 overlap to each other to reduce multiple images.

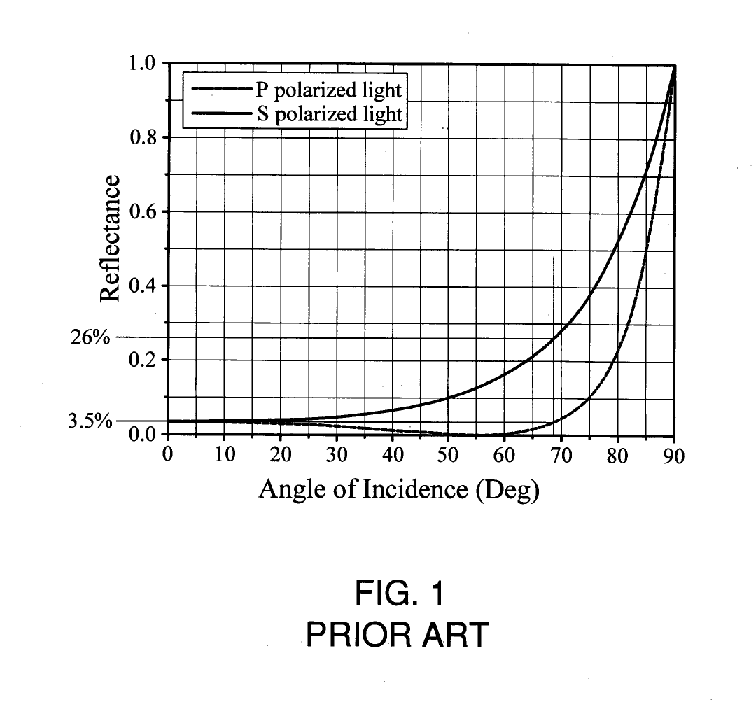

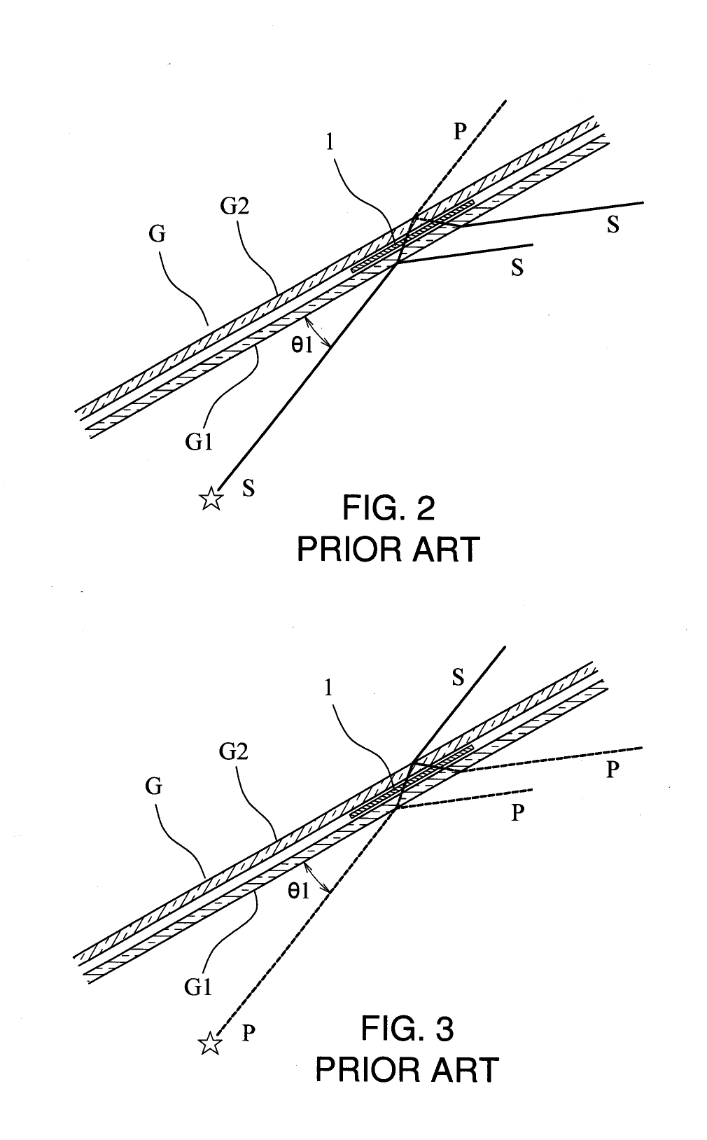

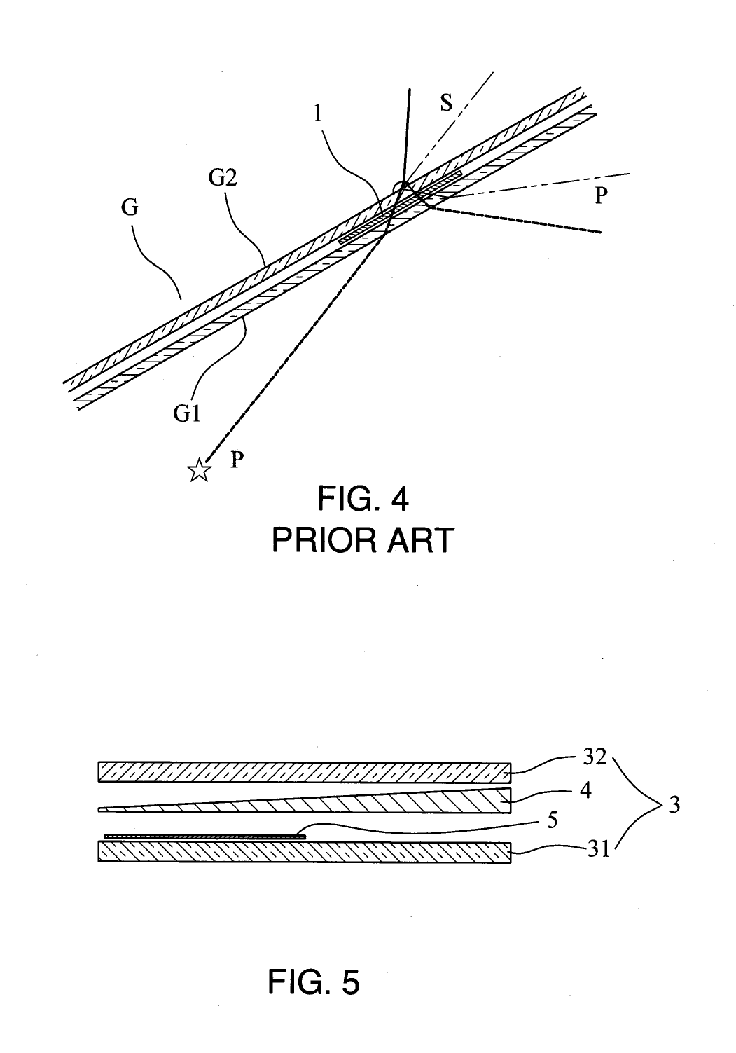

The display device 2 of the present invention projects image lights including 50% of p-polarized light and 50% of s-polarized light, and respectively reflects on the first glass 31 and the outer layer 321 of the second glass 32 along a first light path L1 and a second light path L2, the reflection paths and proportion are shown as FIG. 6; the first light path L1 reflects on the outer layer 311 of the first glass 31, wherein the reflectivity of p-polarized light and s-polarized light could refer to FIG. 1, s-polarized light could obtain 13% (50%×26%) of amount of reflected light, and p-polarized light could obtain 1.7% (50%×3.5%) of amount of reflected light; the second light path L2 obtains transmitted light including 48.3% (50%−1.7%) of p-polarized light and 37% (50%−13%) of s-polarized light on the outer layer 311 of the first glass 31; the transmitted light passes through the half-wave plate 5 between the first glass 31 and the second glass 32, so that p-polarized light and s-polarized light interchange with each other and its proportion becomes 37% of p-polarized light and 48.3% of s-polarized light; it reflects on the outer layer 321 of the second glass 32 and obtains transmitted light including 1.3% (37%×3.5%) of p-polarized light and 12.6% (48.3%×26%) of s-polarized light; it passes through the half-wave plate 5 again, p-polarized light and s-polarized light interchange with each other, its proportion becomes 12.6% of p-polarized light and 1.3% of s-polarized light, it passes the outer layer 311 of the first glass 31 and obtains 12.2% (12.6%×96.5%) of p-polarized light and 1% (1.3%×74%) of s-polarized light. By the above process and the design of the wedge plate 4, the first light path L1 and the second light path L2 meet and it obtains 13.9% (12.2%+1.7%) of p-polarized light and 14% (13%+1%) of s-polarized light to emit to the driver's eye E, so that the driver could obtain images of the head-up display system of all time including approximately half of p-polarized light and half of s-polarized light.

As shown in FIG. 7, which is the second embodiment of the present invention, the head-up display system of all time of the present invention includes:

a display device 2, which includes a projection device 21 and an imaging screen 22 (please refer to the display device 2 shown in FIG. 6);

a windshield 3, which includes a first glass 31 and a second glass 32;

a wedge plate 4, which is set between the first glass 31 and the second glass 32, the wedge plate 4 is a transparent PVB material plate body, the bottom of the wedge plate 4 is attached to the first glass 31;

a half-wave plate 5, which is set between the first glass 31 and the second glass 32, the half-wave plate 5 is a transparent plastic material plate body, the top of the half-wave plate 5 is attached to the second glass 32.

The head-up display system of all time of the present invention, wherein the top of the half-wave plate 5 is attached to the display location of the second glass 32, the bottom of the wedge plate 4 is attached to the top of the first glass 31, the second glass 32 is covered on, and then deaeration and gluing procedures are performed.

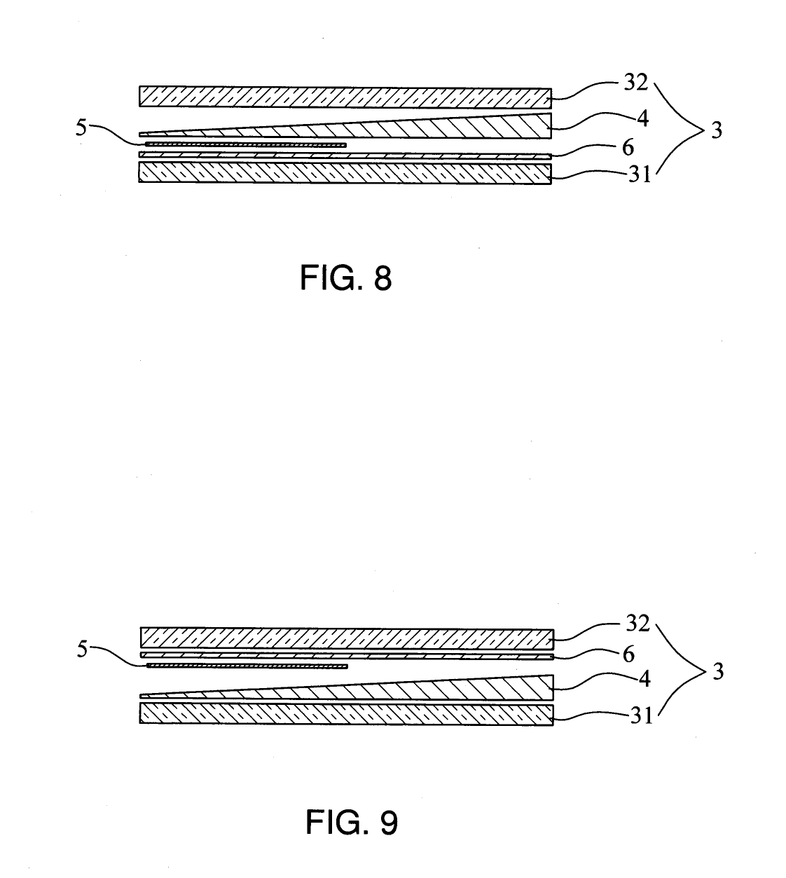

Please refer to FIG. 8, which is the third embodiment of the present invention, the head-up display system of all time of the present invention includes:

a display device 2, which includes a projection device 21 and an imaging screen 22 (please refer to the display device 2 shown in FIG. 6);

a windshield 3, which includes a first glass 31 and a second glass 32;

a wedge plate 4, which is set between the first glass and the second glass, the wedge plate 4 is a transparent PVB material plate body;

a half-wave plate 5, which is set between the first glass 31 and the second glass 32, the half-wave plate 5 is a transparent plastic material plate body;

A transparent plastic plate 6, which is set between the first glass 31 and the second glass 32, the transparent plastic plate 6 is an equal thickness and transparent PVB material plate body.

The head-up display system of all time of the present invention, wherein the half-wave plate 5 is set between the transparent plastic plate 6 and the wedge plate 4, the bottom of the transparent plastic plate 6 is attached to the top of the first glass 31, the second glass 32 is covered on, and then deaeration and gluing procedures are performed.

As shown in FIG. 9, which is a schematic diagram of another implementation of the third embodiment of the present invention, the difference from the implementation in FIG. 8 is that the structure could be changed as that the bottom of the wedge plate 4 is attached to the top of the first glass 31, the second glass 32 is covered on, and then deaeration and gluing procedures are performed.

The second embodiment and the third embodiment of the present invention, wherein the result of the first light path L1 and the second light path L2 projected by the display device 2 is the same as the first embodiment (thus not shown in figure). When the driver wears polarized sunglasses, the light amount of the head-up display system of all time of the present invention becomes halved, and the light amount of environment also becomes halved, the driver could obtain images of the head-up display system of all time including approximately half of p-polarized light and half of s-polarized light. The driver could see images of the head-up display system of all time with wearing sunglasses, and would not feel that it's brightness is too dark or too bright.

The head-up display system of all time of the present invention includes a display device 2, a windshield 3, a wedge plate 4 and a half-wave plate 5, the display device 2 generates approximately equal amount of s-polarized light and p-polarized light, the windshield 3 includes a first glass 31 and a second glass 32, the half-wave plate 5 is set in the middle of the windshield 3. Wherein, s-polarized light reflects on the outer layer 311 of the first glass 31 that the amount of reflection is much greater than p-polarized light, rest of s-polarized light and p-polarized light interchange with each other after transmitting the half-wave plate 5, by the outer layer 321 of the second glass 32, s-polarized light interchanged from the transmitted p-polarized light reflects on the outer layer 321 of the second glass 32 that the amount of reflection is much greater than p-polarized light interchanged from the transmitted s-polarized light, the reflected s-polarized light interchanges into p-polarized light by the half-wave plate 5 and is reflected by the outer layer 311 of the first glass 31. Thus, when it rains, even raindrops attach to the outer layer 321 of the windshield 3, since image light path of HUD does not reflect on the surface with raindrops, there is no image distortion problem. Therefore, the feature of the head-up display system of all time of the present invention could provide drivers with displayed images with optimized visual effects for all time, to improve driving safety effectively.

What is claimed is:

1. A head-up display system of all time, including:
a display device, which is the display device with S-polarized light and P-polarized light;
a windshield, which includes a first glass and a second glass, S-polarized light and P-polarized light projected by the display device are reflected by an outer layer of the first glass and an outer layer of the second glass;
a wedge plate, which is set between the first glass and the second glass;
a half-wave plate, which is set between the first glass and the second glass.

2. The head-up display system of all time as claimed in claim 1, wherein the display device includes a projection device and an imaging screen, the imaging screen is a 45 degree linear polarization, circular polarization or elliptical polarization imaging screen, wherein the ratio of s-polarized and p-polarized light is equal.

3. The head-up display system of all time as claimed in claim 1, wherein the display device includes a projection device and an linear polarized imaging screen by using s-polarized light, a wave plate is covered on the imaging screen, so as to convert output image light into approximately half of s-polarized light and half of p-polarized light in advance.

4. The head-up display system of all time as claimed in claim 1, wherein the display device includes a projection device and an linear polarized imaging screen by using p-polarized light, a wave plate is covered on the imaging screen, so as to convert output image light into approximately half of s-polarized light and half of p-polarized light in advance.

5. The head-up display system of all time as claimed in claim 1, wherein the top of the half-wave plate is attached to the display location of the second glass, the bottom of the wedge plate is attached to the top of the first glass, and the second glass is covered on.

6. The head-up display system of all time as claimed in claim 1, further includes a transparent plastic plate, the half-wave plate is set between the transparent plastic plate and the wedge.

7. The head-up display system of all time as claimed in claim 1, wherein the bottom of the half-wave plate is attached to the display location of the first glass, the bottom of the wedge plate is attached to the top of the first glass and the half-wave plate, and the second glass is covered on.

8. The head-up display system of all time as claimed in claim 1, wherein the display device includes a projection device and an imaging screen.

9. The head-up display system of all time as claimed in claim 1, wherein the half-wave plate is a transparent plastic material plate body.

10. The head-up display system of all time as claimed in claim 1, wherein the wedge plate is a transparent PVB material plate body.
